(19) United States
(12) Patent Application Publication
(10) Pub. No.: US 2016/0373682 A1
(43) Pub. Date: Dec. 22, 2016

(54) METHOD AND APPARATUS FOR VIEWING, MEASUREMENT, AND ASSESSMENT OF SHOOTING ACCURACY

(71) Applicant: Francesco DeAngelis, Herndon, VA (US)

(72) Inventor: Francesco DeAngelis, Herndon, VA (US)

(21) Appl. No.: 15/187,072

(22) Filed: Jun. 20, 2016

Related U.S. Application Data
(60) Provisional application No. 62/182,659, filed on Jun. 22, 2015.

(51) Int. Cl. H04N 5/445; F41J 5/14; H04N 5/232; H04N 5/225; H04N 7/08; G06T 7/00

(52) U.S. Cl. CPC H04N 5/44582; H04N 7/08; G06T 7/0044; H04N 5/23203; G06T 7/0018; H04N 5/2252; F41J 5/14

(57) ABSTRACT

A method and apparatus for viewing, measurement, and assessment of shooting accuracy are provided. The method may include capturing an image or video of one or more targets using one or more image capture and transmission device and transmitting the image or video to one or more image reception and display device, receiving the image or video of the one or more targets and displaying the image or video of the one or more targets on a display of the one or more image reception and display device, selecting one or more shot marks for measurement and assessment for each image or video, performing a pixel analysis method to determine shot error for each of the one or more shot marks for each image or video and calculating a shot group performance for each image or video, and displaying information regarding the shot group performance for each image or video.

### CROSS-REFERENCE TO RELATED APPLICATION(S)

This application claims priority to U.S. Provisional Application No. 62/182,659 filed on Jun. 22, 2015, whose entire disclosure is hereby incorporated by reference.

### BACKGROUND

1. Field

A method and apparatus for viewing, measurement, and assessment of shooting accuracy are disclosed herein.

2. Background

One current method for assessing shooting performance is direct observation by a protected individual near a target, who can see a location of each shot from a distant shooter. A shortcoming of this method is that it requires significant infrastructure and coordination at a range in order to protect the individual and allow the individual to communicate back to the shooter in real time.

Another method typically used with shorter ranges is for all shooting to be temporarily halted and all ammunition unloaded and weapons put into a safe state, while the shooter is given time to walk out and assess his shot performance. Shortcomings of this method include having to disrupt shooting sessions of other shooters, and having to traverse a distance to and from the target which can become time consuming and tiring at long ranges.

Another method is to use a magnifying spotting scope which allows limited assessment of shot placement at a shooter's location based on a distance to a target, magnification and quality of a scope, and weather and lighting conditions. With highest end spotting scopes, precise shot assessment becomes difficult over 300-500 m.

Some current high end shot measurement systems employ sophisticated acoustic processing and communication systems to measure and relay shot errors to a shooter. These systems are for permanent targets and require significant infrastructure and technical expertise to install, configure, and operate. Consequently, they are expensive, not very mobile, and fixed to a single target location during operation. Some camera based systems have recently been introduced with a single fixed camera dedicated to a single target, no error calculation, and no annotation capability of marking shots and adequately recording session information. These systems provide some limited use in viewing shots at long distances, but not the kind of capability needed for very precise assessment.

### BRIEF DESCRIPTION OF THE DRAWINGS

Embodiments will be described in detail with reference to the following drawings in which like reference numerals refer to like elements, and wherein:

FIG. 1 is a schematic diagram of an apparatus for viewing measurement, and assessment of shooting accuracy according to an embodiment;

FIG. 2 is a schematic diagram of an apparatus for viewing measurement, and assessment of shooting accuracy according to another embodiment;

FIG. 3 is a flow chart of a method for viewing, measurement, and assessment of shooting accuracy according to an embodiment;

FIG. 4 is a schematic diagram of a reception and display device according to an embodiment;

FIG. 5 is a schematic diagram of a reception and display device according to another embodiment;

FIG. 6 is a schematic diagram of a reception and display device according to another embodiment;

FIG. 7 is a schematic diagram of a reception and display device according to another embodiment; and

FIG. 8 is a schematic diagram of a reception and display device according to another embodiment.

### DETAILED DESCRIPTION

Embodiments disclosed herein provide a method and apparatus that allow marksmen and instructors to view and assess shooting performance up to very long ranges (over 2000 yds) in both real time and after the fact. The method and apparatus according to embodiments disclosed herein allow a shooter to monitor multiple targets from a single portable apparatus and/or for an instructor to monitor multiple shooting lanes in real time. Shot annotation capabilities allow corrections to be marked for each shot through image processing and analytics, while error and group performance statistics are calculated using a pixel analysis method. The method and apparatus according to embodiments disclosed herein also allow recorded session information to be reviewed after the fact to evaluate performance and provide recommendations and corrective actions.

The method and apparatus according to embodiments disclosed herein may include one or more image capture and transmission device, such as a video camera and transmitter, which may be placed near one or more targets. The one or more image capture and transmission device may transmit a live or recorded image or video of one or more of the targets to one or more reception and display device, which may allow user or users to clearly see the image or video and assess shot performance by observing a location of shots or bullet holes along with reviewing calculated errors.

For example, the one or more image capture and transmission device may include a video camera (analog or digital) and an adjustable mechanical mount that allows the video camera to be aimed at a target, or a pan-tilt-zoom (PTZ) camera, which may he remotely aimed, zoomed, and focused on any targets within its range. The one or more image capture and transmission device may include a transmitter (analog or digital), and may provide a live or recorded image or video to, for example, a personal computer, laptop computer, notebook computer, tablet computer, or smartphone, or a video monitor for visual guidance during an initial setup process through a wired or wireless connection. The reception and display device may include an internal or external receiver (analog or digital) to receive an image or video signal from the transmitter. Audio signals may also be transmitted and received.

A software based user interface may be provided, which may allow a user to record parameters and/or annotate shots and/or save images or video clips to an electronic storage. The software may also provide shot error calculations based on pixel analysis of shot images, and performance statistics for designated shot groups. Shot images may be selected by a user via an input (not shown) of the image reception and display device, or processed automatically. The software may provide for remote aiming, zooming, and focusing of the video camera at the one or more targets. As set forth above, the video camera may be, for example, a PTZ camera. The software may also provide a calibration process by which image data may be initially calibrated to support the pixel analysis method.

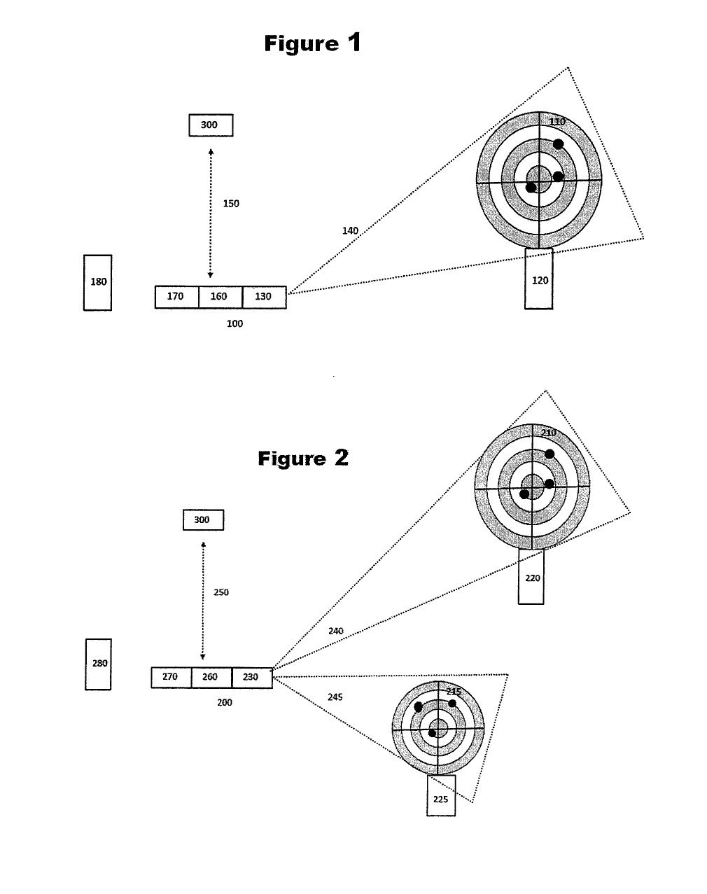

FIG. 1 is a schematic diagram of an apparatus for viewing, measurement, and assessment of shooting accuracy according to an embodiment. FIG. 1 shows image capture and transmission device 100 positioned in front of target 110, which may be positioned on a target stand 120. The image capture and transmission device 100 may include an image capture device 130, such as a video camera, which may be aimed and focused on target 110 using a reception and display device 300 to view an image or video transmitted by the image capture and transmission device 300 over a wireless link 150 during an initial setup and alignment process and thereafter. The image capture device 130 may be set up so that target 110 may be seen clearly in a field of view 140 in order to get a complete and close up image or video.

The image capture and transmission device 100 may further include a transmitter 160. After initial alignment and setup, the transmitter 160 may transmit the image or video from the image capture device 130 to the reception and display device 300, which may be located near a shooting position. The image capture and transmission device may further include a battery 170 as a power source.

Optionally, a shield 180 may be positioned between the image capture and transmission device 100 and the shooting position. The shield 180 may protect the image capture and transmission device 100 from bullet damage. Some or all of the components of the image capture and transmission device 100 may be in a rugged portable enclosure.

FIG. 2 is a schematic diagram of an apparatus for viewing, measurement, and assessment of shooting accuracy according to another embodiment. FIG. 2 shows image capture and transmission device 200 positioned in front of a plurality of targets 210 and 215, which may be positioned on a plurality of target stands 220 and 225, respectively. Image capture device 230, which may be, for example, a PTZ camera, may be aimed, zoomed, and focused on targets 210 and 215, which may be different sizes and distances away, using reception and display device 300 to view an image or video over wireless link 250 during the initial setup and alignment process and thereafter.

Upon shooting, transmitter 260 may transmit the image or video from the image capture device 230 to the reception and display device 300, which may be positioned near a shooting position. The reception and display device 300 may remotely pan, tilt, and zoom image capture device 230 to alternate between the multiple targets 210 and 215 and change a zoom level, focus, or other parameters. The image capture and transmission device 200 may include battery 270 as a power source.

Optionally, a shield 280 may be positioned between the image capture and transmission device 200 and a shooting position. The shield 280 may protect the image capture and transmission device 200 from bullet damage. Some or all of the components of image capture and transmission device 200 may be in a rugged portable enclosure.

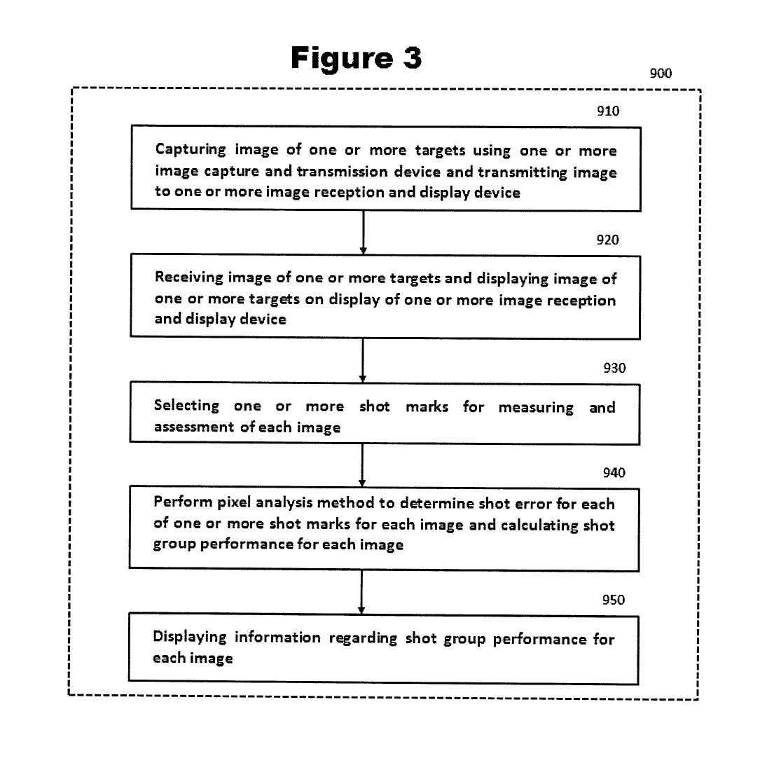

FIG. 3 is a flow chart of a method for viewing, measurement, and assessment of shooting accuracy according to an embodiment. The method may be implemented using the apparatus discussed above, for example. The method 900 may include capturing an image or video of one or more targets, such as targets 110, 210, 215, using one or more image capture and transmission device, such as image capture and transmission device 100, 200, and transmitting the image or video to one or more image reception and display device, such as image reception and display device 300, in S910; receiving the image or video of the one or more targets and displaying the image or video of the one or more targets on a display of the one or more image reception and display device, in S920; selecting one or more shot marks for assessment for each image or video, in S930; performing a pixel analysis method to determine shot error for each of the one or more shot marks for each image or video and calculating a shot group performance for each image or video, in S940; and displaying information regarding the shot group performance for each image or video, in S950. Shot errors may be calculated using a pixel analysis method according to an embodiment. An overall group center of mass and average errors may be displayed along with other statistics. The pixel analysis method according to an embodiment may involve an initial target calibration process. The calibration process may select two or more points on the image or video. The points may then be associated with known distances on the target. Positions of the bullet holes may then be mathematically calculated from locations of pixels corresponding to the bullet holes.

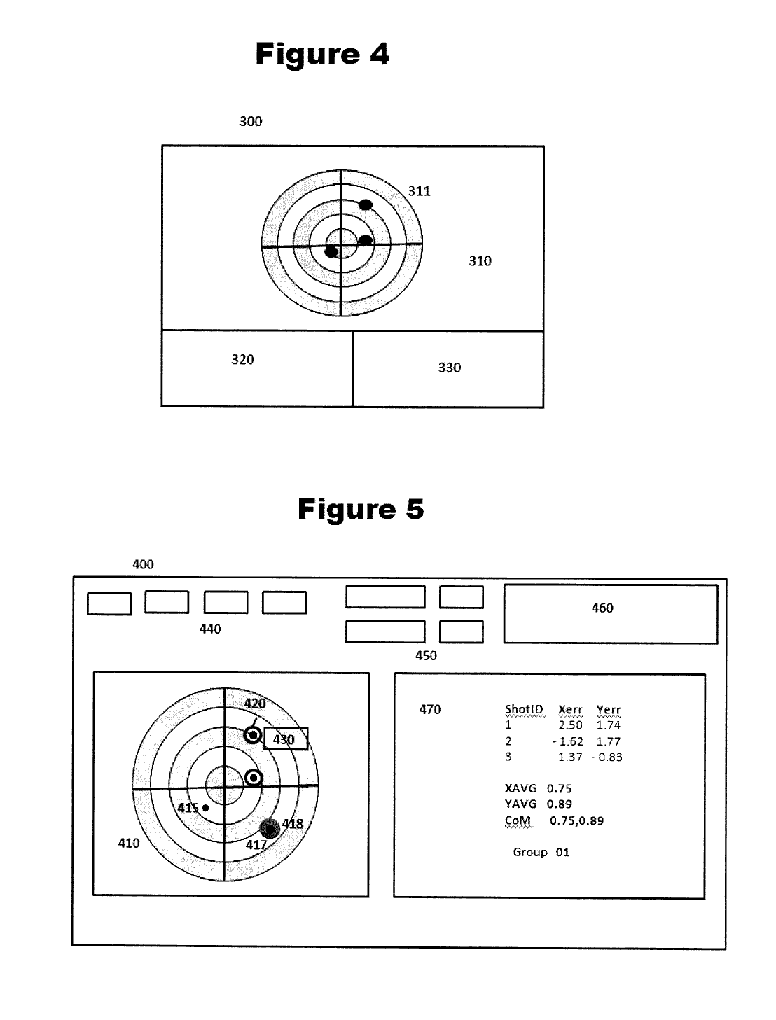

FIG. 4 is a schematic diagram of a reception and display device according to, an embodiment, FIG. 4 shows an embodiment of the reception and display device 300, which may receive a signal on receiver 330 and display an image 311 of a target on a screen or display window 310. Battery 320 may power the reception and display device 300.

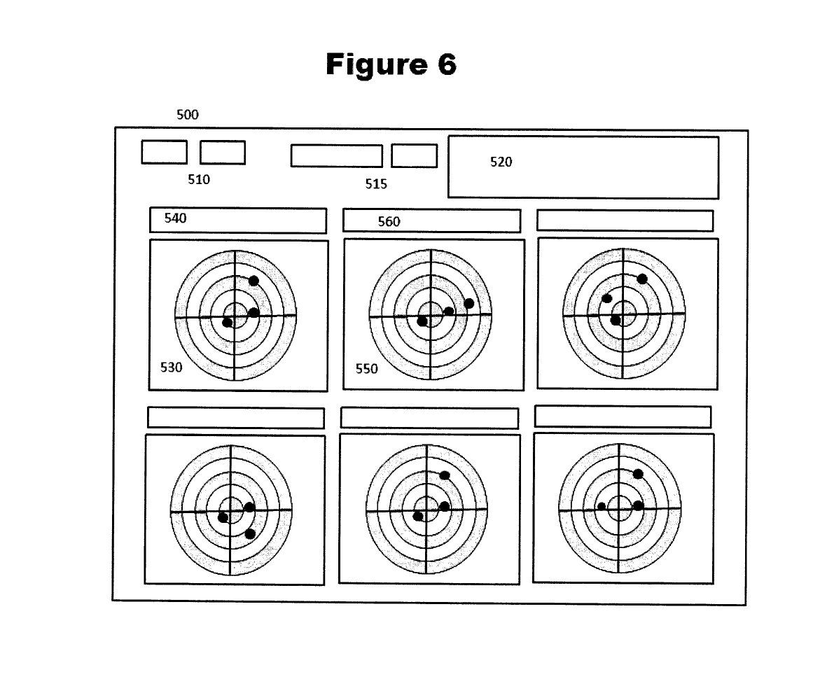

FIG. 5 is a schematic diagram of a reception and display device according to another embodiment. FIG. 5 shows an embodiment of a reception and display device displaying a live or recorded image or video along with useful metadata and graphical overlays. Screen or display window 410 shows the live or recorded image or video with bullet hole 415 among others. A graphic overlay 420 may include a bullet hole Shot ID marker, while graphic overlay 430 may be a note box containing information, such as, for example, an elevation, angle, and other shot related data. Virtual controls 440 may provide functions, such as calibration, configuration settings, view full screen, PTZ control snapshot, audio on/off, record, save file, hide/view statistics, and hide/view annotations, for example. Text boxes 450 may allow a user to annotate a shooting session with fields for name, course, weapon, ammunition, range, instructor, and temperature, for example. Notes field 460 may allow any additional information to be entered for each session. Screen or display window 470 may show individual shot errors coinciding with marked shot ID's in the live or recorded image or video, which may be calculated using a pixel analysis method according to an embodiment. An overall group center of mass and average errors may be displayed along with other statistics. The pixel analysis method according to an embodiment may involve an initial target calibration process. The calibration function in virtual controls 440 may be used to select two or more points on the live image. The points may then be associated with known distances on the target. Positions of the bullet holes may then be mathematically calculated from locations of pixels corresponding to the bullet holes.

FIG. 6 is a schematic diagram of a reception and display device according to another embodiment. FIG. 6 shows an embodiment of a multiple lane monitoring application by which two or more shooting lanes may be monitored by an instructor or other viewer, which may be done simultaneous to a shooter viewing his own session independently. The reception and display device 500 according to this embodiment may allow a user to select how many live or recorded image or video feeds 530,550 to display simultaneously. Each live or recorded image or video feed (shooting lane) may be labeled and annotated in text boxes above each screen or display window 540,560. Virtual controls 510 may provide functions, such as video window configuration, view full screen, PTZ control, audio, snapshot, and record, for example. Text boxes 515 may allow a user to annotate a shooting session with fields for name, course, weapon, ammunition, range, instructor, and temperature, for example. Notes field 520 may allow any additional information to be entered fore session.

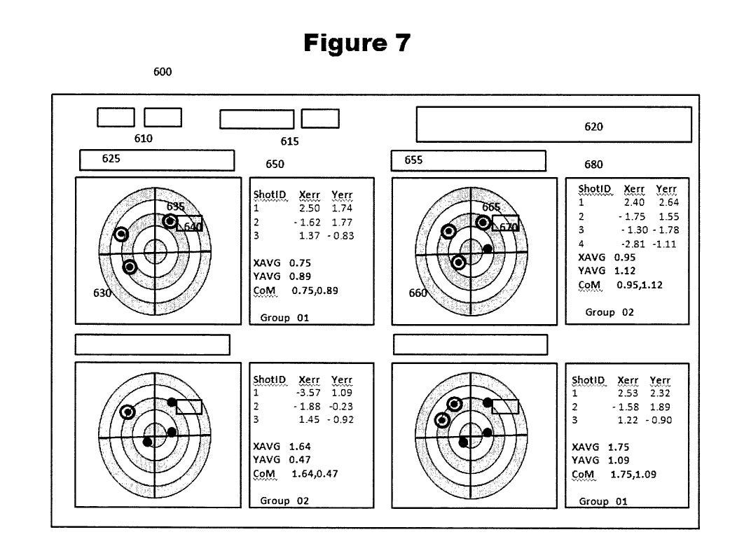

FIG. 7 is a schematic diagram of a reception and display device according to another embodiment. FIG. 7 shows an embodiment of a multiple lane monitoring application by which two or more lanes may be set up, configured, and monitored by an instructor or other viewer, which may be done simultaneous to a shooter viewing his own session independently. The reception and display device 600 according to this embodiment may allow a user to select how many live or recorded image or video feeds 630,660 to display simultaneously. Each live or recorded image or video feed (shooting lane) may be labeled and annotated in the text boxes above each screen or video window 625,655. A user may set up each lane calibrating and configuring each camera. When a shot has occurred, a bullet hole may be selected and marked or automatically marked with Shot ID 635,665, and shot parameters may optionally be recorded in note boxes 640,670. Virtual controls 610 may provide functions, such as video window configuration, view full screen, target calibration, PTZ control, audio snapshot, and record, for example. Text boxes 615 may allow a user to annotate a shooting session with fields for name, course, weapon, ammunition, range, instructor, and temperature, for example. Notes field 620 may allow any additional information to be entered for a session.

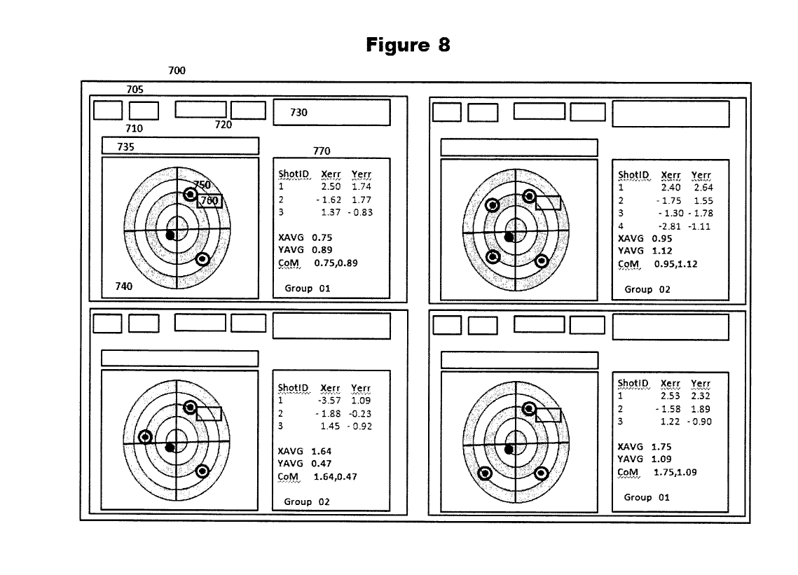

FIG. 8 is a schematic diagram of a reception and display device according another embodiment. FIG. 8 shows an embodiment of a multiple lane monitoring application by which two or more lanes may be monitored by an instructor or other viewer directly from an individual shooter or lane display computers. The reception and display device 700 according to this embodiment may allow a user to select how many live or recorded image or video feeds 705 from display computers of multiple shooters to display simultaneously. Each image or video feed 705 may come from a screen of a given shooter's display computer and may include virtual control buttons 710, information text boxes 720, notes box 730, and optional lane marker/annotation box 735, which may each be an overlay that allows the multiple lane viewer to label the lanes. Live or recorded image or video feed 748 from each screen may also be shown, with bullet hole marker Shot ID's 750, shot note boxes 760, and error and statistics display 770.

Embodiments disclosed herein provide a method and apparatus that allow a shooter or marksman and/or instructor to precisely monitor marksmanship performance while shooting at one or mare targets, both in real time and after the fact. Embodiments disclosed herein provide a camera based apparatus placed near one or more targets that captures a precise image or video of each target and transmits the image or video in real time to one or more receivers/displays at which the shooter or marksman and/or instructor may clearly see an impact of each shot on the target, and assess/adjust his performance accordingly.

Software may allow the shooter or marksman to enter data and parameters related to a target, an environment, a weapon and ammunition, weather, a range and terrain, and other related data, for example. The software may also allow the user to mark each bullet hole as it appears in a target image. The bullet hole may be tagged with a sequence number and may be annotated with windage and elevation values used along with any other relevant correction parameters. This data may help the shooter or marksman keep track of each shot and make informed corrections.

As practicing shooters know, it becomes difficult to discern which bullet hole is which in a cluster of bullet holes, even with a best current equipment. The software may calculate an error of each shot using pixel analysis techniques on the bullet hole in the calibrated live or recorded image or video. The error may be combined with other designated shots to calculate shot group statistics. The software may also allow images to be recorded as either snapshots or video clips and reviewed post event for further analysis or digitally provided to a trainer or evaluator for further analysis of shooting performance. With a marked chronological sequence of shots, their respective parameters annotated and positions displayed on a target image, and the calculated errors and group performance statistics, a trainer or evaluator may assess shooting performance in real time or after the fact using the recorded data. This is very useful for marksmen training on their own with limited time, infrastructure, or resources, or for instructors managing one or multiple simultaneous sessions.

Embodiments disclosed herein may be implemented as a capture and record embodiment, which allows for post event viewing and analysis, or a real time only embodiment. The capture and record embodiment may be based upon capturing, transmitting, viewing, annotating, and recording images or video of the target. The real time only embodiment may be based on capturing, transmitting, and viewing real time images or video of the target.

The descriptions herein have been made with reference to particular embodiments in order to illustrate the principals, methodologies, and application. Numerous modifications may be made to the embodiments herein and additional embodiments constructed without departing from the scope as defined by the following claims.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for viewing, measurement, and assessment of shooting accuracy, the method comprising:
capturing an image or video of one or more targets using one or more image capture and transmission device and transmitting the image or video to one or more image reception and display device;
receiving the image or video of the one or more targets and displaying the image or video of the one or more targets on a display of the one or more image reception and display device;
selecting one or more shot marks for measurement and assessment for each image or video;
performing a pixel analysis method to determine shot error for each of the one or more shot marks for each image or video and calculating a shot group performance for each image or video; and
displaying information regarding the shot group performance for each image or video.

2. The method of claim 1, wherein the one or more shot marks are either manually or automatically selected.

3. The method of claim 1, wherein the image or video of the one or more targets is transmitted to multiple users at the one or more reception and display device simultaneously.

4. The method of claim 3, wherein the multiple users include several categories of users including shooter and instructor and the one or more reception and display device have software with different viewing capabilities.

5. The method of claim 1, wherein a user at one of the one or more reception and display device is capable of receiving images or videos from a plurality of image capture and transmission devices in order to simultaneously view and access shooting activity in multiple lanes by multiple shooters.

6. The method of claim 1, wherein the one or more image capture and transmission device is a video camera and transmitter located near the one or more targets, and the one or more reception and display device is at least one of a personal computer, notebook computer, tablet computer, or smart phone.

7. The method of claim 6, wherein the video camera and transmitter is an analog or digital video camera coupled to an analog or digital transmitter.

8. The method of claim 7, wherein the transmitter is a digital transmitter in the form of a WiFi radio, Ethernet radio, or other Internet Protocol based radio.

9. The method of claim 6, wherein the video camera is an analog or digital pan-tilt-zoom (PTZ) camera capable of being remotely aimed and controlled by one or more users.

10. The method of claim 1, wherein software is provided on the one or more reception and display device capable of displaying real time video imagery with annotation capabilities on an application interface and/or as a video overlay.

11. The method of claim 1, wherein the pixel analysis method includes interpolation/extrapolation of shot positions of the one or more shot marks based on pixel locations.

12. The method of claim 11, wherein a calibration process is used to register two or more points on the image or video to known distances on the target.

13. The method of claim 1, wherein software is provided on the one or more reception and display device capable of displaying real time video imagery with optional annotation capabilities for multiple shooting sessions or lanes such that an instructor or other user may monitor multiple shooters simultaneously.

14. The method of claim 1, wherein the image or video of the one or more targets is transmitted from one or more shooters with the one or more reception and display device to multiple users with the one or more reception and display device via a modulated optical signal or a cable or wireless transmission.

15. The method of claim 1, wherein software is provided on the one or more reception and display device configured to allow a user to annotate relevant parameters, such as name, instructor, weapon, ammunition parameters, shooting range name, lane number, target range, temperature, humidity, and range.

16. The method of claim 1, wherein software is provided on the one or more reception and display device configured to allow a user to mark each shot and optionally to annotate each shot with notes or parameters or cover selected shots, which are not of interest in the selected group, with a virtual patch, so that a location on the target may be re-used.

17. The method of claim 1, wherein software is provided on the one or more reception and display device configured to automatically detect and mark each shot using the pixel analysis method on the image or video or frames of the image or video.

18. The method of clam 17, wherein the performing the pixel analysis method includes detecting pixel level changes across multiple frames of the image or video.

19. The method of claim 1, wherein software is provided on the one or more reception and display device configured to allow a user to capture and store images or videos as snapshots or video clips.

20. The method of claim 1, wherein the one or more reception and display device is used to view, aim, and configure the one or more image reception and capture device during initial setup with a corresponding target.

21. The method of claim 1, wherein the one or more reception and display device displays the shot errors and current shot group performance and/or exports the shot errors and/or accuracy calculations as a data file for import to a spreadsheet or other numerical analysis program.

22. The method of claim 1, wherein some or all of components of the one or more image capture and transmission device is housed in a weather resistant enclosure.

23. The method of claim 1, wherein the one or more image capture and transmission device is battery-operated.

24. The method of claim 1, further including placing a shield between the one or more image capture and transmission device and a shooter to protect the one or more image capture and transmission device from damage.

25. The method of claim 1, wherein the one or more image reception and display device includes a high gain external antenna.

26. The method of claim 1, further including transmitting audio information from the one or more targets so that bullet impacts may be heard by a shooter and/or other users.

27. Apparatus for viewing, measurement, and assessment of shooting accuracy, the apparatus including:
one or more image capture and transmission device configured to capture and transmit an image or video of one or more targets;
one or more image reception and display device configured to receive transmission of the image or video transmitted by the one or more image capture and transmission device, perform a pixel analysis method on the image or video to determine shot errors for each of one or more shot marks selected for each image or video for measurement and assessment, calculate a shot group performance for each image or video, and display information regarding the shot group performance for each image or video.

28. The apparatus of claim 27, wherein the one or more image capture and transmission device is a video camera and transmitter located near the one or more targets, and the one or more reception and display device is at least one of a personal computer, notebook computer, tablet computer, or smart phone.

28. The apparatus of claim 27, wherein the video camera and transmitter is an analog or digital video camera coupled to an analog or digital transmitter.

30. The apparatus of claim 29, wherein the transmitter is a digital transmitter in the form of WiFi radio, Ethernet radio, or other Internet Protocol based radio.

31. The apparatus of claim 27, wherein the video camera is an analog or digital pan-tilt-zoom (PTZ) camera capable of being remotely aimed and controlled by one or more users at the one or more image reception and display device.

32. The apparatus of claim 27, wherein the pixel analysis method includes interpolation/extrapolation of shot positions of the one or more shot marks based on pixel locations.

33. The apparatus of claim 32, wherein a calibration process is used to register two or more points on the image or video to known distances on the target.

34. The apparatus of claim 27, wherein some or all of components of the one or more image capture and transmission device is housed in a weather resistant enclosure.

35. The apparatus of claim 27, wherein the one or more image capture and transmission device is battery-operated.

36. The apparatus of claim 27, further including a shield between the one or more image capture and transmission device and a shooter to protect the one or more image capture and transmission device from damage.

37. Apparatus for viewing, measurement, and assessment of shooting accuracy, the apparatus comprising:
means for capturing an image or video of one or more targets using one or more image capture and transmission device and transmitting the image or video to one or more image reception and display device;
means for receiving the image or video of the one or more targets and displaying the image or video of the one or more targets on a display of the one or more image reception and display device;
means for selecting one or more shot marks for measurement and assessment for each image or video;
means for performing a pixel analysis method to determine shot errors for each of the one or more shot marks for each image or video and calculate a shot group performance for each image or video; and
means for displaying information regarding the shot groups performance for each image or video.
